(19) United States
(12) Patent Application Publication
(10) Pub. No.: US 2009/0011083 A1
(43) Pub. Date: Jan. 8, 2009

(54) Modified Vegetable Protein Having Low Levels of Phytic Acid, Isoflavones and Ash

(75) Inventors: Theodore M. Wong, Ballwin, MO (US); Kwang-Chung Hou, Chesterfied, MO (US); Carl P. Rose, JR., St. Louis, MO (US); Daniel U. Staerk, Kirkwood, MO (US)

Correspondence Address: Solae, LLC, 4300 Duncan Avenue, Legal Department E4, St. Louis, MO, 63110, US

(73) Assignee: SOLAE, LLC, St. Louis, MO (US)

(21) Appl. No.: 12/167,429

(22) Filed: Jul. 3, 2008

Related U.S. Application Data
(60) Provisional application No. 60/947,929, filed on Jul. 3, 2007.

(51) Int. Cl. A23J 3/14; A23J 3/18; A23J 3/30; A23J 3/34

(52) U.S. Cl. 426/52; 426/656

(57) ABSTRACT

This invention is directed to a vegetable protein composition comprising a protein material having low levels of isoflavones, low levels of phytic acid and/or phytates, and moderate levels of ribonucleic acids. Many vegetable compositions described additionally have high protein content, low manganese content, low ash content, and enhanced storage stability in liquid form. Processes for preparing such vegetable protein compositions are also disclosed.

### FIELD OF THE INVENTION

This invention relates to a vegetable protein composition having low phytic acid content, low isoflavone content and moderate levels of RNA. The vegetable protein composition can also have an increased ratio of calcium to phosphorous and low ash content compared to currently available vegetable protein compositions.

### BACKGROUND OF THE INVENTION

Phytic acid is represented by the below Formula I.

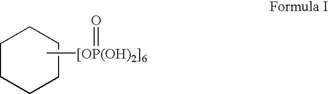

Phytic acid or phytate is the hexa-phosphorus ester of inositol (1,2,3,4,5,6-cyclohexanehexolphosphoric acid), found in many seeds and cereals. It acts as the primary storage form of both phosphorus and inositol and accounts for as much as 50% of the total phosphorus content in seeds and cereals. Phytic acid in plants appears in the form of calcium, magnesium and potassium salts, which in general are called phytin. A large part of the phosphorus content of seeds is stored in these compounds. For example, about 70% of the total phosphorus in soybeans is accounted for by phytin. When the terms phytate or phytic acid are used herein, it is intended to include salts of phytic acid and molecular complexes of phytic acid with other vegetable constituents.

In typical commercial soy protein isolation processes, defatted soy flakes or soy flour are slurried with water and a base and extracted at pH values between 8.0 and 10.0 to solubilize proteins. The slurry is centrifuged to separate the insoluble part from the solution. The major protein fraction is recovered from the solution by precipitating at a pH near the isoelectric point of the protein (4.5), separating it by centrifugation, washing the precipitate with water, redispersing it at pH 7, and spray-drying it to a powder. In such processes, phytic acid will follow the protein and tends to concentrate in the resulting soy protein product. The phytic acid content of commercial soy protein isolates ranges from about 1.2 to about 3%, whereas phytic acid content of soybeans typically ranges from 1 to 2% phytic acid.

Many food and beverage products include protein supplements derived from vegetable materials such as soybeans, beans, peas, other legumes, and brassica such as canola, rapeseed, and mustard. Vegetable protein materials, particularly soy, are used to fortify infant formulas by increasing the nutritional value of the formula, and to provide protein content approximate to that of the protein content of human breast milk.

In order for the vegetable protein composition to more closely approximate human breast milk, low levels of isoflavones, phytic acid, phytates, ash, and minerals bound to phytic acid and phytates such as phosphorus, calcium, magnesium, manganese, chloride, iron, zinc, and copper are required. It is desirable to provide improved compositions of isolated soy proteins and soy protein concentrates with reduced levels of these components.

### SUMMARY OF THE INVENTION

The present invention is directed to vegetable protein compositions having low phytic acid concentration, low isoflavone concentration, and low ash wherein liquids containing such compositions are storage stable, and the processes for preparation thereof.

Among the various aspects of the invention is a vegetable protein composition having an isoflavone content of less than 0.6 mg aglycone per gram vegetable protein, a ribonucleic acid (RNA) content of at least about 5,000 mg/kg, a total inositol phosphate content measured as the sum of an inositol-6-phosphate (IP6) content, an inositol-5-phosphate (IP5) content, an inositol-4-phosphate (IP4) content, and an inositol-3-phosphate (IP3) content of less than about 8 μmol per gram vegetable protein, and less than about 0.4 wt. % phytic acid based on the total weight of the vegetable protein composition.

Another aspect is a soy protein isolate having an isoflavone content of less than 0.7 mg aglycone per gram soy protein, a ribonucleic acid (RNA) content of at least about 5,000 mg/kg, a total inositol phosphate content measured as the sum of an inositol-6-phosphate (IP6) content, an inositol-5-phosphate (IP5) content, an inositol-4-phosphate (IP4) content, and an inositol-3-phosphate (IP3) content of less than about 8 μmol per gram soy protein, and less than about 0.4 wt. % phytic acid based on the total weight of the soy protein isolate.

The aspects described above can also have many other characteristics. For example, the degree of hydrolysis is less than about 6.5%; less than about 5.7%; or the vegetable protein can be unhydrolyzed. Further, the compositions described above can have an ash content of less than 2.5% on an as is basis, a manganese content of less than about 10 ppm, a protein content greater than about 90% on a moisture-free basis, and/or a viscosity less than 10 cps when measured at 10% solids content and room temperature. Additionally, the compositions described herein can have a calcium to phosphorus weight ratio of from about 1.2:1 to about 2.5:1.

Yet another aspect of the present invention is a process for making a vegetable protein composition from a protein-containing material comprising the steps of treating a vegetable protein curd with a phytase enzyme not having protease side activity to form a phytase-treated vegetable protein material; and solubilizing and separating the phytase-treated vegetable protein material to form the vegetable protein composition. The weight ratio of an aqueous extractant to the protein-containing material for the process is from 16:1 to 70:1.

The process described above can have a weight ratio of an aqueous extractant to a starting protein-containing feed for the process from 16:1 to 70:1; from 20:1 to 70:1; from 30:1 to 70:1; from 40:1 to 70:1; from 50:l to 70: l; or from 60:1 to 70:1.

The processes described above can further comprise extraction of the protein-containing material to form a solubilized protein slurry. Also, the processes described above can further comprise precipitation of the solubilized protein slurry to form a precipitated protein curd and an aqueous whey. Further, the processes described above can further include separating the precipitated protein curd from the aqueous whey. Additionally, the processes described above can further comprise solubilizing and separating the phytase-treated protein curd to form the vegetable protein composition.

A further aspect of the invention is a food product containing the vegetable protein composition or soy protein isolate described above.

Other objects and features will be in part apparent and in part pointed out hereinafter.

### BRIEF DESCRIPTION OF THE DRAWINGS

FIG. 1 is a flowchart depicting an embodiment of the current invention having one solubilizing and centrifuge step.

FIG. 2 is a flowchart depicting an embodiment of the current invention having two solubilizing and centrifuge steps.

### DETAILED DESCRIPTION OF THE INVENTION

The protein containing plant material of the present invention may be any vegetable or animal protein. Preferred protein sources useful in the composition of the present invention include soy protein, corn protein, canola protein, rapeseed protein, pea protein, wheat protein, rice protein, and combinations thereof. In preferred embodiments, zein, canola, wheat gluten, and soy are the source of the proteins. Most preferably, soy is the source of the protein. Specialized phytases (with or without protease side activity) can be added at different steps in the process to reduce the phytic acid content. The phytate degrading enzyme provides an easy and commercially attractive method for preparing low-phytate and phytate-free soy protein isolates without exposing the proteins to high alkalinity which decreases their nutritive value and at which a very light, suspended phytate precipitate, which cannot be separated with commercial continuous separators, is formed. The phytate degrading enzyme can also provide a phytate-free soy protein isolate without exposing the proteins to temperatures above 65° C., which may affect the solubility and other functional properties of the protein. Also, contact of soy protein with living microorganisms and expensive and time-consuming purification steps, such as ultrafiltration and ion-exchange treatments, is not required. In addition, extensive solubilization is used to facilitate the removal of minerals and isofilavones from the compositions.

### Vegetable Protein Compositions

The vegetable compositions of the present invention have low levels of isoflavones, low levels of phytic acid and/or phytates, and moderate levels of ribonucleic acids. In many preferred embodiments, the vegetable compositions described additionally have one or more of the following characteristics: a high protein content, a low manganese content, a low ash content, and enhanced storage stability as compared to an identical composition that has not been treated with a phytase enzyme without protease side activity. In particularly preferred embodiments, the vegetable protein composition is a soy protein composition.

Advantageously, the vegetable compositions have low levels of phytic acid and/or phytates. Phytic acid is also known as inositol-6-phosphate (IP6) and inositol-5-phosphate (IP5), inositol-4-phosphate (IP4), and inositol-3-phosphate (IP3) are collectively known as phytates. In various embodiments, the total inositol phosphate content measured as the sum of an IP6 content, an IP5 content, an IP4 content, and an IP3 content is less than about 8 μmol per gram vegetable protein. In many embodiments, the sum of an IP6 content, an IP5 content, an IP4 content, and an IP3 content is less than about 7, 6.5, 6, 5.5, or 5 μmol per gram vegetable protein. The inositol phosphate content can be determined using the method described in N. G. Carlsson, N. G.; E. L. Bergman; K. Hasselblad and A. S. Sandberg, Rapid Analysis of Inositol Phosphates, J. Agri. Food Chem. 2001, Vol. 49, pp. 1695-1701. The phytic acid content can be determined using the method described in Official Methods of Analysis of the AOAC, (1995) 16th Ed, Method 986.11, Locator # 32.5.18.

For a typical protein isolate, the IP6 content is from about 15 to about 30 μmol/g, the IP5 content is from about 1 to about 2 μmol/g, and the IP4 content and the IP3 content are both non-detectable. In the course of treating a protein to reduce the IP6 content, sequentially the IP5 content, the IP4 content and IP3 content are increased. For example, in reducing the IP6 content from 22 μmol/g to 3.5 μmol/g in some compositions of the invention, the IP5 content may increase to not more than 1.5 μmol/g, the IP4 content increases from non-detectable to not more than 1.1 μmol/g, and the IP3 content increases from non-detectable to not more than 1.8 μmol/g. Subsequently, the soluble materials can be removed by washing.

The vegetable compositions described herein additionally have an isoflavone content of less than 0.6 mg aglycone per gram vegetable protein. In many embodiments, the isoflavone content is less than 0.5, 0.4, or 0.3 mg aglycone per gram vegetable protein. The isoflavone content can be determined using the method described in A. Seo and C. V. Morr, Improved High Performance liquid Chromatographic Analysis of Phenolic Acids and Isoflavones from Soy Protein Products, J. Agr. Food Chem. 1984, Vol. 32, pp. 530-533.

Additionally, the vegetable compositions described herein have a ribonucleic acid (RNA) content of greater than about 5000 mg/kg. In many embodiments, the RNA content is greater than about 6000, 7000, 8000, 9000, 10,000 mg/kg, or more. The RNA content can be determined using the method described in James L. Leach, Jeffrey H. Baxter, Bruce E. Molitor, Mary B. Ramstack, and Marc L. Masor, “Total potential available nucleosides of human milk by stage of lactation.” Am. J. Clinical Nutri. 1995, Vol. 61, pp. 1224-30. The RNA content can be described according to Leach, et al. that it is total potential available nucleotides (TPAN). It comprises monomeric, polymeric ribonucleotides and ribonucleoside content. The RNA content can be maintained at this level without supplementing the composition with additional RNA. In other words, the RNA content can be retained from the native vegetable protein source.

Furthermore, the vegetable protein compositions can optionally have one or more of the following characteristics. The vegetable protein compositions can have a protein content of at least about 90%, 91%, 92%, 93%, 94%, 95%, 96%, 97%, or more on a moisture-free basis. The manganese content of the composition can be less than about 7, 6, 5, or 4 ppm. The manganese content can be determined using the method described in Official Methods of Analysis of the AOAC (1995) 16th Ed., Method 968.08, Locator #4.8.02. Also, the ash content of the vegetable protein compositions can be less than about 2.5%, 2%, or 1.5% based on the weight of the protein composition on a moisture-free basis. The ash content can be detennined using the method described in Annual ASTM Standard, (1972), Part 15, DI 797-62, Philadelphia, Pa.

Preferably, the vegetable protein composition has the proper degree of hydrolysis to obtain the desired viscosity. Depending on the end application, the viscosity can be adjusted to the desired parameters. For this application, the viscosity of the vegetable protein composition is less than about 10 cps when measured in a suspension having 10% solids content and at room temperature.

The protein material may be denatured to lower its viscosity when it is added to a liquid. Chemical denaturation and hydrolysis of protein materials is well known in the art and typically consists of treating a protein material with one or more alkaline reagents in an aqueous solution under controlled conditions of pH and temperature for a period of time sufficient to denature and hydrolyze the protein material to a desired extent. Typical operating range is a pH of 9-10 for 30 minutes at 50° C.

Hydrolysis of the protein material may also be affected by treating the protein material with an enzyme capable of hydrolyzing the protein. Many enzymes are known in the art which hydrolyze protein materials, including, but not limited to, fungal proteases, microbial proteases, plant proteases, animal protease, and chymotrypsin and exopeptidases. Enzyme hydrolysis is affected by adding a sufficient amount of enzyme to an aqueous dispersion of protein material, typically from about 0.01% to about 10% enzyme by weight of the protein material, and treating the enzyme and protein dispersion at a temperature, typically from about 5° C. to about 75° C. and a pH, typically from about 2 to about 9, at which the enzyme is active for a period of time sufficient to hydrolyze the protein material. After sufficient hydrolysis has occurred the enzyme is deactivated by heating to a temperature above 75° C.

A modified soy protein material can be used and is a soy protein isolate that has been enzymatically hydrolyzed and deamidated under conditions that expose the core of the proteins to enzymatic action as described in European Patent No. 0 480 104 B1, which is incorporated herein by reference. Briefly, the modified protein isolate material disclosed in European Patent No. 0 480 104 B1 is formed by: 1) forming an aqueous slurry of a soy protein isolate; 2) adjusting the pH of the slurry to a pH of from 9.0 to 11.0; 3) adding between 0.01 and 5% of a proteolytic enzyme to the slurry (by weight of the dry protein in the slurry); 4) treating the alkaline slurry at a temperature of 10° C. to 75° C. for a time period effective to produce a modified protein material having a molecular weight distribution (Mn) between 800 and 4000 and a deamidatioin level of between 5% to 48% (typically between 10 minutes to 4 hours); and deactivating the proteolytic enzyme by heating the slurry above 75° C. The modified protein material disclosed in European Patent No. 0 480 104 B1 is commercially available from Solae, LLC of St. Louis, Mo. as Supro® XT10C, Supro® XT219, and Supro® XT220.

### Processes for Preparing Low Phytic Acid Protein Isolates

The vegetable protein composition having the properties described above can be prepared by the following processes.

To reduce the phytic acid/phytates (i.e., inositol phosphate) concentration, it is necessary to employ phytate-degrading enzymes. The phytate-degrading enzymes react with the inositol-6-phosphate and the inositol-5-phosphate to generate inositol and orthophosphate as well as several forms of inositol phosphates as intermediate products. Phytate-degrading enzymes useful to prepare the vegetable proteins described herein are phytases and acid phosphatases; preferably, the phytate-degrading enzyme is a phytase having no protease side activity. Particularly preferred enzymes are Peniophora lycii phytase EC 3,1,3,26, a food grade phytase designated Novozymes Phytase NS 37032 and disclosed in WO 1995/028850. Novozymes Phytase NS 37032 is a phytase preparation produced by Aspergillus oryzae expressing the gene encoding phytase from Peniophora lycii. Novozymes has determined that Novozymes Phytase NS 37032 (a food grade phytase) is generally recognized as safe for use in acid beverages and infant formula. Phytase is produced by various microorganisms such as Aspergillus sp., Rhizopus sp., and yeasts (Appl. Microbiol. 16:1348 1357 (1968; Enzyme Microb. Technol. 5:377 382 (1983)). Phytase is also produced by various plant seeds, for example wheat, during germination. According to methods known in the art, enzyme preparations can be obtained from the above mentioned organisms. Caransa et al. Netherlands Pat. Appl. 87.02735, incorporated by reference herein, found that at the same enzyme dosage phytase from Aspergillus sp. degraded phytic acid in corn more efficiently than phytase from wheat.

Novozymes Phytase NS 37032 is discussed in a paper titled, “Expression, Gene Cloning, and Characterization of Five Novel Phytases from Four Basidiomycete Fungi: Peniophora lycii, Agrocybe pdediades, a Ceriporia sp., and Trametes pubescens.” Soren F. Lassem, et al. 2001. Applied and Environmental Microbiology, vol. 67, No. 10, Pages 4701-4707.

The amount of phytate-degrading enzyme required will depend upon the phytic acid content of the raw material and the reaction conditions. The right dosage can easily be estimated by a person skilled in the art. Generally the concentration of the phytate degrading enzyme is from about 500 to about 2200, preferably from about 600 to about 2100 and most preferably from about 720 to about 1400 units of phytase (phytase unit) per gram of protein, which is usually expressed as PU/g. An increased amount of phytase can be used. One Phytase Unit (PU) is defined as the amount of enzyme which under standard conditions (i.e. at pH 5.5, 37° C. a substrate concentration of 5.0 mM sodium phytate, and a reaction time of 30 minutes) liberates 1 μmol of phosphate per minute.

Alternatively, the concentration of the phytate degrading enzyme can be expressed as a percent curd solid basis (CSB). A 0.2% CSB means that if 1000 parts curd are present as solids, then the amount of phytase employed is 2 parts. Preferably, the enzyme preparation comprises such an amount of one or more phytate-degrading enzymes that the phytic acid in soy beans is substantially degraded. The phytate degrading enzyme provides an easy and commercially attractive method for preparing low-phytate and phytate-free soy protein isolates without exposing the proteins to high alkalinity which decreases their nutritive value and at which a very light, suspended phytate precipitate, which cannot be separated with commercial continuous separators, is formed. The phytate degrading enzyme can also provide a substantially phytate-free soy protein isolate without exposing the proteins to temperatures above 65° C., which may affect the solubility and other functional properties of the protein. Also, contact of soy protein with living microorganisms and expensive and time-consuming purification steps, such as ultrafiltration and ion-exchange treatments, is not required.

For the processes described below, the total process water in the curd-making process is typically about 16:1 to about 70:1 pounds of water per pound of protein-containing material (e.g., ratio of aqueous extractant:flake). This means that the total water used from the first step to the last step has the ratio as compared to the weight of the starting feed. This overall ratio is important for providing vegetable protein compositions having the desired properties, but the ratios of aqueous extractant:flake used at each individual process step is not as important as the overall ratio of the aqueous extractant used as compared to the amount of starting flake. In various preferred embodiments, the ratio of aqueous extract:flake is from about 20:1 to about 70:1; from about 30:1 to about 70:1; from about 40:1 to about 70:1; from about 50:1 to about 70:1; and from about 60:1 to about 70:1.

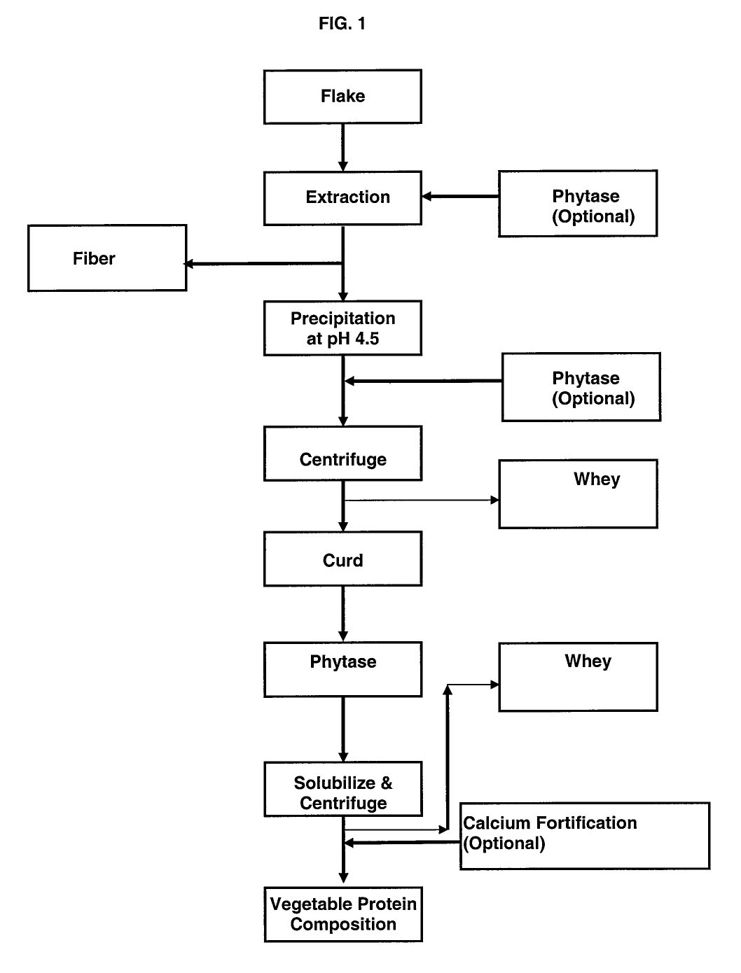

Referring now to FIG. 1, one embodiment of the process of the present invention is shown. The process begins with introducing protein-containing feed such as protein-containing flakes into an extraction stage along with water and optional processing aids as are known in the art. Water is added to the extraction at a ratio of at least about 8 pounds of water per 1 pound of protein-containing feed. The preferable temperature of the water is less than about 140° F. (60° C.). Processing aids can include sodium sulfite. The pH of the extraction is as is, preferably about 6.5 to about 7. The retention time for the mixture of the protein-containing feed and water in the extraction stage is typically about 15 minutes. In addition, the insoluble soy fiber is removed by filtration and/or centrifugation. The extraction stages described herein could also be done in a counter current process as is known in the art.

The exiting process stream from the extraction stage is then fed to a precipitation stage for precipitating the protein. The exiting stream from the extraction stage is a slurry comprised of solubilized protein, and may contain proximate such as ash, sugars, acid soluble protein, other solubles and water. In the precipitation stage, the pH of the slurry is adjusted to near the isoelectric point of the protein (e.g., pH of about 4 to 5 depending on the type of protein) to form precipitated protein curd and a soluble aqueous whey. Various food grade acidic reagents can effectuate precipitation such as acetic acid, sulfuric acid, phosphoric acid, hydrochloric acid or others. More typically, precipitation is effectuated with food grade hydrochloric acid or phosphoric acid. Furthermore, the exiting extract could be treated with the phytase enzyme.

The precipitated protein curd and aqueous whey exiting the precipitation stage are introduced to a separation stage to recover the protein curd. The apparatus used for separation is typically a centrifuge (e.g., centrifuge stage in FIG. 1). A water displacement wash is used typically at a ratio of at least about 2 pounds of water per 1 pound of protein-containing feed introduced into the extraction stage. The washing and separation stage apparatus separates the precipitated protein (e.g., curd in FIG. 1) from the aqueous whey. The discharge of solids is minimized to avoid yield losses. The aqueous whey is discharged from the process. The phytase enzyme could be introduced to the precipitate above prior to the first centrifuge.

The solids of the curd (or cake) from the centrifuge is then adjusted to a maximum of about 15% solids and introduced to a phytase stage. In this stage the process stream of protein curd enters a series of mixing tanks containing the phytase enzyme. The residence time of the protein curd is typically about 40 to 60 minutes. The tanks are typically held at a temperature of from about 30° C. to about 60° C.

Typically, the phytate-degrading enzyme used in the phytase stage is a phytase such as Novozymes Phytase NS 37032. The concentration of phytate-degrading enzyme used varies depending upon the phytic acid content of the raw material. Typically, the amount of phytate-degrading enzyme added during the phytase stage is from about 0.1 to about 0.3% curd solids basis.

The process stream may then be introduced to a solubilization and separation stage (e.g., solubilize and centrifuge in FIG. 1) to concentrate the protein solids in the process stream. During this stage the solids are reslurried by introducing water at a ratio of at least about 5 pounds of water per 1 pound of protein-containing feed introduced into the extraction stage. More typically, within that range, the ratio of water used is at least about 15 pounds per 1 pound of protein-containing feed introduced into the extraction stage (15:1). The reslurried stream is typically diluted to about 2% to about 5% solids. The pH of the stream is also adjusted to about 5. The adjustment of pH is typically accomplished by addition of an alkali blend of sodium hydroxide and potassium hydroxide. The reslurried stream is typically heated to at least about 125° F. (51.6° C.). Following solubilization, the reslurried stream is subjected to a separation step; the apparatus used for separation is typically a centrifuge.

The cake from the centrifuge is considered the vegetable protein composition (see FIG. 1). This vegetable protein composition can be subjected to dilution with water and neutralization prior to a pasteurization process that is typically carried out at a temperature of about 305° F. (151.7° C.). The residence time for pasteurizing the stream is typically about 9 seconds.

The pasteurized protein curd can then be dried by conventional means, such as by utilizing a spray drying apparatus, to form the vegetable protein composition of the invention.

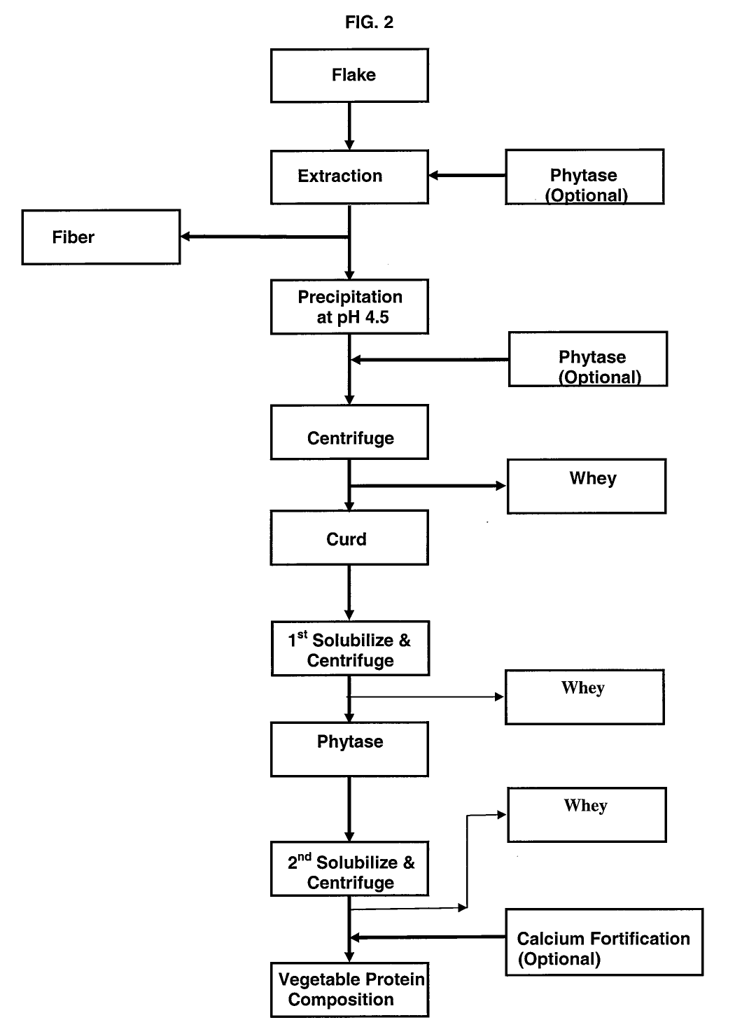

Another embodiment of the process of the invention is shown in FIG. 2. The process described in FIG. 2 differs from the process of FIG. 1 by adding a first solubilization and separation step (e.g., 1st solubilize and centrifuge in FIG. 2) between the curd stage and the phytase stage. This solubilization and separation stage is similar to the solubilization and separation stage described above in connection with FIG. 1.

In the optional steps, an additional phytase treatment can be performed during the first extraction stage or between the precipitation stage and the first separation stage. These phytase treatments are similar to the phytase stage described above in connection with FIG. 1. Further, an optional calcium fortification stage can be performed after the solubilization and centrifuge stage (FIG. 1) or after the second solubilization and centrifuge stage (FIG. 2). This process is disclosed in U.S. Pat. No. 7,022,355, which is incorporated herein by reference.

Preferably, the vegetable protein compositions described above comprise soy protein. Soybean protein materials which can be used as starting materials are soy flour and soy concentrate. The soy flour or soy concentrate is formed from a soybean starting material which may be soybeans or a soybean derivative. Preferably, the soybean starting material is either soybean cake, soybean chips, soybean meal, soybean flakes, or a mixture of these materials. The soybean cake, chips, meal, or flakes may be formed from soybeans according to conventional procedures in the art, where soybean cake and soybean chips are formed by extraction of part of the oil in soybeans by pressure or solvents, soybean flakes are formed by cracking, heating, and flaking soybeans and reducing the oil content of the soybeans by solvent extraction, and soybean meal is formed by grinding soybean cake, chips, or flakes.

Soy flour can be full fat, enzyme-active, or defatted. As these terms are used herein, a full fat soy flour contains ground whole soybeans containing all of the original oil, usually 18% to 20%. This full fat flour can be enzyme-active or it can be heat-processed or toasted to minimize enzyme action. Enzyme-active soy flour is a full fat soy flour that is minimally heat-treated to keep the natural enzyme activity. Defatted soy flour refers to a comminuted form of defatted soybean material, preferably containing less than 1% oil, formed of particles having a size such that the particles can pass through a No. 100 mesh (U.S. Standard) screen. The soy cake, chips, flakes, meal, or mixture of the materials are comminuted into a soy flour using conventional soy grinding processes. Soy flour has a protein content of from about 49% to about 65% on a moisture free basis (mfb). Preferably the flour is very finely ground, most preferably so that less than about 1% of the flour is retained on a 300 mesh (U.S. Standard) screen.

Soy concentrate, as the term is used herein, refers to a soy protein material containing from about 65% to less than 90% of soy protein (mfb). Soy concentrate is preferably fonned from a commercially available defatted soy flake material from which the oil has been removed by solvent extraction. The soy concentrate is produced by an acid leaching process or by an alcohol leaching process. In the acid leaching process, the soy flake material is washed with an aqueous solvent having a pH at about the isoelectric point of soy protein, preferably at a pH of about 4 to about 5, and most preferably at a pH of about 4.4 to about 4.6. The isoelectric wash removes a large amount of water soluble carbohydrates and other water soluble components from the flakes, but removes little of the protein and fiber, thereby forming a soy concentrate. The soy concentrate is dried after the isoelectric wash. In the alcohol leaching process, the soy flake material is washed with an aqueous ethyl alcohol solution wherein ethyl alcohol is present at about 60% by weight. The protein and fiber remain insoluble while the carbohydrate soy sugars of sucrose, stachyose, and raffinose are leached from the defatted flakes. The soy soluble sugars in the aqueous alcohol are separated from the insoluble protein and fiber and the insoluble protein and fiber are dried to form the soy concentrate.

Soy protein isolate, as the term is used herein, refers to a soy protein material containing at least 90% protein content, and preferably from about 95% or greater protein content (mib).

Preferably the protein material used in the present invention, is modified to enhance the characteristics of the protein material. The modifications are modifications which are known in the art to improve the utility or characteristics of a protein material for certain applications and include, but are not limited to, denaturation and protease hydrolysis of the protein material.

With regards to the calcium fortification step, the composition can have an increase in the calcium to phosphorous weight ratio (Ca:P) in the range of about 1.2:1 to about 2.5:1.

These compositions can be used for various food products including a beverage, a snack product, a meat, and a meat substitute. Further, the beverage could be a dry blended beverage, a ready-to-drink beverage, a ready to feed product, an infant formula, and a mixture thereof. Also, the snack product can be a cereal or a snack bar.

For various ready-to-drink beverages, such as infant formula, the vegetable protein compositions are particularly suitable due to their ability to be incorporated into stable emulsions and not undergo sedimentation. This stability is partially due to the degree of hydrolysis of the proteins and the use of a phytase that does not have protease side activity when removing phytic acid and other phytates.

Having described the invention in detail, it will be apparent that modifications and variations are possible without departing from the scope of the invention defined in the appended claims.

### EXAMPLES

The following non-limiting examples are provided to further illustrate the present invention.

The characteristics of the soy protein compositions prepared in Examples 1 to 6 are detailed in Table 1.

TABLE 1

| Sample Number | Example 1 | Example 2 | Example 3 | Example 4 | Example 5 | Example 6 |
|---|---|---|---|---|---|---|
| | 500E-type | 0.2% | | 0.2% | 0.2% | 0.2% Phytase, |
| Description | (control) | Phytase | 0.2% Phytase | Phytase | Phytase | 0.035% Protease |
| Actual water Process | 24:1 | 38.5:1 | 45.6:1 | 55.3:1 | 56:1 | 56:1 |
| Protein, (%) | 88.8 | 91.4 | 91.5 | 91.4 | 90.7 | 91.8 |
| Moisture, (%) | 4.0 | 4.2 | 5.0 | 3.6 | 5.0 | 4.1 |
| Dry Basis Protein, (%) | 92.5 | 95.4 | 96.3 | 94.8 | 95.5 | 95.7 |
| Total Isoflavones, | 3.15 | 0.72 | 0.50 | 0.35 | 0.77 | 0.75 |
| (mg/g protein DB) | | | | | | |
| Isoflavones, (mg | 1.80 | 0.47 | 0.34 | 0.24 | 0.57 | 0.55 |
| (aglycone equiv.)/ | | | | | | |
| g protein DB) | | | | | | |
| Phytic acid, (%) | 1.77 | 0.14 | 0.33 | 0.24 | 0.22 | 0.14 |
| Manganese, (ppm) | 12.5 | 6.1 | 7.0 | 4.4 | 6.0 | 4.0 |
| Ash, (%) | 3.9 | 1.8 | 1.9 | 1.7 | 2.0 | 2.5 |

DB = dry basis

### Example 1

### Control Sample 2

A control sample was produced as a comparison. Approximately 54 pounds of sulfited (0.3% flake weight basis (FWB)) acidic curd was produced from defatted flour. The pH was adjusted to 9.7 at the first extraction with calcium hydroxide. The combined extract was adjusted to 4.5 pH with hydrochloric acid and washed with 2:1 water (FWB) and reslurried with 5:1 water (FWB) prior to concentration. Total process water usage in the cured-making process was about 24:1 (FWB). The concentrated cake was diluted to 13.52% solids and the pH was adjusted to 7.17 with sodium hydroxide prior to sterilization. The curd was sterilized at 305° F. (151.7° C.) for 9 seconds and flash cooled to 185° F. (85° C.). The resulting curd was spray dried and approximately 15 pounds were collected. This sample is labeled as S500E type of control sample. This protein isolate had a total phytic acid content of 1.77%. The sum of IP6, IP5, IP4, and IP3 contents was 23.4 μmol/g.

### Example 2

Approximately 88 pounds of sulfited (0.3% FWB) acidic curd were produced from defatted flour. The pH was not adjusted during extraction. The combined extract was adjusted to 4.5 pH with hydrochloric acid and washed with 3:1 water (FWB) and reslurried with 12.25:1 water (FWB) prior to the first concentration. The first concentrated cake was diluted to approximately 15% solids and treated with Novozymes Phytase NS 37032 (5000 KPU/mL) in a two-tank, 40 minutes, continuous hydrolysis. The enzyme was initially spiked into the system at an addition level of 1.0% CSB for the first 60 minutes of processing but backed down to 0.2% CSB for the remainder. The phytase-treated curd was diluted in-line to approximately 4.81% and the pH was adjusted with the alkali blend (42% NaOH/58% KOH) to pH 5.0 prior to final concentration. Due to the initial spike of enzyme and additional line-out time needed for this process, the first 100 pounds of concentrated cake was discarded. Total process solubilizing water usage in the curd-making process was 38.5:1 (FWB). The concentrated cake collected after the discarded 100 pounds was diluted to about 16% solids and pH adjusted to 6.8 with sodium hydroxide prior to sterilization. The curd was sterilized at 305° F. (151.7° C.) for 9 seconds and flash cooled to 185° F. (85° C.). The resulting curd was spray di-led and approximately 21.5 pounds were collected.

### Example 3

Approximately 73 pounds of sulfited (0.3% FWB) acidic curd were produced from defatted flour. The pH was not adjusted during extraction. The combined extract was adjusted to 4.5 pH with hydrochloric acid and washed with 4:1 water (FWB) and reslurried with 16.25:1 water (FWB) prior to the first concentration. The first concentrated cake was diluted to approximately 15% solids and treated with Novozymes Phytase NS 37032 (5000 KPU/mL) in a two-tank, 40 minute, continuous hydrolysis. The enzyme was initially spiked into the system at an addition level of 1.0% CSB for the first 60 minutes of processing but backed down to 0.2% CSB for the remainder. The phytase-treated curd was diluted in-line to approximately 3.69% and pH adjusted with the alkali blend (42% NaOH/58% KOH) to pH 5.0 prior to final concentration. Due to the initial spike of enzyme and additional line-out time needed for this process, the first 100 pounds of concentrated cake was discarded. Total process solubilizing water usage in the curd-making process was 45.6:1 (FWB). The concentrated cake collected after the discarded 100 pounds was diluted to 16.11% solids and pH adjusted to 6.8 with sodium hydroxide prior to sterilization. The curd was sterilized at 305° F. (151.7° C.) for 9 seconds and flash cooled to 185° F. (85° C.). The resulting curd was spray dried and approximately 17.8 pounds were collected.

### Example 4

Approximately 56 pounds of sulfited (0.3% FWB) acidic curd were produced from defatted flour. The pH was not adjusted during extraction. The combined extract was adjusted to 4.5 pH with hydrochloric acid and washed with 4:1 water (FWB) and reslunied with 24:1 water (FWB) prior to the first concentration. The first concentrated cake was diluted to approximately 14% solids and treated with Novozymes Phytase NS 37032 (5000 KPU/mL) in a two-tank, 40 minute, continuous hydrolysis. The enzyme was initially spiked into the system at an addition level of 1.0% CSB for the first 60 minutes of processing but backed down to 0.2% CSB for the remainder. The phytase-treated curd was diluted in-line to approximately 4.32% and pH adjusted with the alkali blend (42% NaOH/58% KOH) to pH 5.0 prior to the final concentration. Due to the initial spike of enzyme and additional line-out time needed for this process, the first 100 pounds of concentrated cake was discarded. Total process solubilizing water usage in the curd-making process was 55.3:1 (FWB). The concentrated cake collected after the discarded 100 pounds was diluted to 15.5% solids and pH adjusted to 6.76 with sodium hydroxide prior to sterilization. The curd was sterilized at 305° F. (151.7° C.) for 9 seconds and flash cooled to 185° F. (85° C.). The resulting curd was spray dried and approximately 15.8 pounds were collected.

### Example 5

Defatted and ground soybean flakes were continuously metered into a flake wet-in system at 100 pounds of water per 10 pounds of flakes (the water:flake=10:1 ratio.). The water temperature was 90° F. (32.2° C.) and the extraction retention time was 15 minutes. A 0.3% sodium sulfite was added to the extraction tank and no other alkali was used. The first extract slurry was fed to a centrifugal separating device to separate the soluble extract from the insoluble spent flakes. The second extraction was accomplished by mixing the spent flakes stream with 90° F. (32.2° C.) water at 60 pounds of water per 10 pounds of flakes rate (6: 1), followed by a separation of the soluble extract from the insoluble spent flakes. The clarified extract from the last separation was sent forward in the process. Total water usage prior to precipitation was 160 pounds per 10 pounds of flakes. The spent flakes from the last precipitation step were conveyed to a dryer for further processing for other uses.

The combined clarified extracts were continuously precipitated in-line to a pH of 4.4 to 4.5 with hydrochloric acid. Precipitated extracts were transferred to the washing feed tank.

The precipitated extract was fed to a centrifugal separating device for washing. A disc centrifuge was used for washing and the precipitated extract solids increased to 6 to 7% total solids at the discharge of the machine. A displacement wash of 30 pounds of water per 10 pounds of flakes as used. The effluent volume solids were minimized to avoid yield losses.

The underflow from the disc centrifuge was reconstituted with 90° F. (32.2° C.) water at 150 pounds of water per 10 pounds of flakes. This diluted mix was then heated in-line to 135° F.±5° F. (57.2±5° C.) and fed to a solid bowl centrifuge. The exiting cake was diluted with hot water at the discharge chute to roughly 15% and 125° F. (51.7° C.). Total water usage to flake ratio was 56:1 in this case.

A solution of Novozymes Phytase NS 37032 was added to the curd at 0.3% enzyme on a curd solids basis (CSB). The curd was then passed through a disintegrator so that the cake particles were reduced in size to permit more efficient release and removal of isoflavones. Enzyme treatment temperature was 125° F. (51.7° C.) and adequate mixing for minimum foam generation was used. The pH was adjusted to 5.0 after 40 minutes of enzyme treatment.

The curd was diluted in-line with 90° F. (51.7° C.) water at 130 pounds water per 10 pounds flakes. This diluted mix was then heated in-line to 135° F. (57.2° C.) and fed to a solid bowl centrifuge. Pinion speed on this centrifuge was maximized for cake compaction and removal of isoflavones without increasing the speed to the point where the centrifuge locked up.

The diluted cake from the concentration step was pumped through a disintegrator and then passed through a strainer. The curd was adjusted to pH 7 and further diluted to appropriate viscosity for pasteurization at 305° F. (151.7° C.) for 9 seconds to inactivate enzyme; then the product was spray-dried.

### Example 6

A similar process to Example 5 was used except that the Novozymes Phytase NS 37032 concentration was 0.1% of curd solid basis and the water:flake ratio was 56:1. Other differences from the process in Example 5 were that the curd was diluted to 15% before spray drying, treated with 0.035% protease (based on curd solids) at 142° F. (61.1° C.) for 45 minutes, and then adjusted to pH 7 followed by pasteurization and spray drying.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and methods without departing from the scope of the invention, it is intended that all matter contained in the above description shall be interpreted as illustrative and not in a limiting sense.

What is claimed:

1. A vegetable protein composition having an isoflavone content of less than 0.6 mg aglycone per gram vegetable protein, a ribonucleic acid (RNA) content of at least about 5,000 mg/kg, a total inositol phosphate content measured as the sum of an inositol-6-phosphate (IP6) content, an inositol-5-phosphate (IP5) content, an inositol-4-phosphate (IP4) content, and an inositol-3-phosphate (IP3) content of less than about 8 μmol per gram vegetable protein, and less than about 0.4 wt. % phytic acid based on the total weight of the vegetable protein composition.

2. The composition of claim 1 wherein the degree of hydrolysis is less than about 6.5%.

3. The composition of claim 1 wherein the degree of hydrolysis is less than about 5.7%.

4. The composition of claim 1 wherein the vegetable protein is unhydrolyzed.

5. The composition of claim 1 having an ash content of less than 2.5% on an as is basis.

6. The composition of claim 1 having a manganese content of less than about 10 ppm.

7. The composition of claim 1 having a protein content greater than about 90% on a moisture-free basis.

8. The composition of claim 1 having a viscosity less than 10 cps when measured at 10% solids content and room temperature.

9. The composition of claim 1 having a calcium to phosphorus weight ratio of from about 1.2:1 to about 2.5:1.

10. The composition of claim 1 wherein the vegetable protein is soy protein, corn protein, canola protein, rapeseed protein, pea protein, wheat protein, rice protein, or a combination thereof.

11. The composition of claim 1 wherein the vegetable protein is a soy protein.

12. The composition of claim 1 wherein the vegetable protein is a canola protein.

13. The composition of claim 1 wherein the vegetable protein composition comprises a soy protein isolate having an isoflavone content of less than 0.7 mg aglycone per gram soy protein, a ribonucleic acid (RNA) content of at least about 5,000 mg/kg, a total inositol phosphate content measured as the sum of an inositol-6-phosphate (IP6) content, an inositol-5-phosphate (IP5) content, an inositol-4-phosphate (IP4) content, and an inositol-3-phosphate (IP3) content of less than about 8 μmol per gram soy protein, and less than about 0.4 wt. % phytic acid based on the total weight of the soy protein isolate.

14. The isolate of claim 13 wherein the degree of hydrolysis is less than about 6.5%.

15. The isolate of claim 13 having an ash content of less than 2.5% on an as is basis.

16. The isolate of claim 13 having a manganese content of less than about 10 ppm.

17. The isolate of claim 13 having a viscosity less than 10 cps when measured at 10% solids content and room temperature.

18. A process for making a vegetable protein composition from a protein-containing material comprising the steps of:
treating a vegetable protein curd with a phytase enzyme not having protease side activity to form a phytase-treated vegetable protein material; and
solubilizing and separating the phytase-treated vegetable protein material to form the vegetable protein composition
wherein the weight ratio of an aqueous extractant to the protein-containing material for the process is from 16:1 to 70:1.

19. The process of claim 18 wherein the weight ratio of an aqueous extractant to the protein-containing material for the process is from 30:1 to 70:1.

20. A food product containing the vegetable protein composition of claim 1.

21. An infant formula containing the vegetable protein composition of claim 1.
